(19) United States
(12) Patent Application Publication
(10) Pub. No.: US 2010/0191607 A1
(43) Pub. Date: Jul. 29, 2010

(54) ORDER ACCEPTING DEVICE AND METHOD OF DISPLAYING NUMBER OF ORDERS

(75) Inventors: Akio Hiruma, Shizuoka (JP); Hisashi Sato, Shizuoka (JP); Takashi Makiyama, Tokyo (JP); Yumiko Okuma, Tokyo (JP); Masanori Sambe, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/691,113

(22) Filed: Jan. 21, 2010

(30) Foreign Application Priority Data
Jan. 26, 2009 (JP) 2009-014621
Aug. 5, 2009 (JP) 2009-182759

(51) Int. Cl. G06Q 30/00; G06Q 10/00; G06F 3/048

(52) U.S. Cl. 705/21; 705/24; 715/810

(57) ABSTRACT

An order accepting device includes: an addition unit which, every time a menu button having an article name attached thereto and accepting an operation by an operator is operated, adds a count value indicating the number of orders of an article corresponding to the operated menu button; and a first count display unit which displays the count value indicating the number of orders obtained by the addition unit, on the menu button.

### CROSS-REFERENCE TO RELATED APPLICATION

This application is based upon and claims the priority of Japanese Patent Applications No. 2009-014621, filed on Jan. 26, 2009, and No. 2009-182759, filed on Aug. 5, 2009, the entire contents of which are incorporated herein by reference.

### TECHNICAL FIELD

The present invention relates to an order accepting device and a method for displaying the number of orders installed in an eating and drinking place such as a restaurant and adapted to assist in customer services by inputting guide information for customers, order information of items on the menu, and so on.

### BACKGROUND

In many eating and drinking places, for example, family restaurants and bars, an order management system is constructed that can integrally manage orders of food and drink items on the menu to accounting (see JP-A-2008-299821). The system disclosed in JP-A-2008-299821 includes an accounting device such as an electronic cash register or POS (point of sales) terminal installed on the cash desk, which is the accounting place where the bill is paid, a station which executes management of various kinds of information sent from the accounting device, a slip issuing printer which is connected to the accounting device and prints and issues order slips, and a kitchen printer which prints and outputs cooking indication slips. The station, the slip issuing machine, the kitchen printer and the accounting device are connected via a communication network such as a LAN (local area network).

In the accounting device disclosed in JP-A-2008-299821, orders are inputted by an operator touching each menu button in a menu item section in an order input screen. Then, in the case of consecutively touching a menu button plural times for an order of plural units of the same item, the operator checks an order list displayed near the order input screen in order to confirm whether the number of times of touching reaches the number of orders.

However, the operator's checking of the order list displayed near the order input screen in order to confirm whether the number of times of touching reaches the number of orders causes very poor operability and burden on the operator.

### SUMMARY

In view of the foregoing, it is an object of the invention to provide an order accepting device and a method of displaying the number of orders that realize very high operability and convenience for the operator.

An order accepting device according to an aspect of the invention includes: an addition unit which, every time a menu button having an article name attached thereto and accepting an operation by an operator is operated, adds a count value indicating the number of orders of an article corresponding to the operated menu button; and a first count display unit which displays the count value indicating the number of orders obtained by the addition unit, on the menu button.

A method for displaying the number of orders according to another aspect of the invention is executed in an order accepting device which has, for each article, a menu button having an article name attached thereto and accepting an operation by an operator. The order accepting device has a control unit and a storage unit. The method includes the following, which is executed by the control unit: an addition unit adding a count value indicating the number of orders of an article corresponding to the operated menu button every time the menu button is operated; and a first count display unit displaying the count value indicating the number of orders obtained by the addition unit, on the menu button.

### DESCRIPTION OF THE DRAWINGS

FIG. 1 is a view of system configuration schematically showing the overall configuration of a customer service assistance system.

FIG. 2 is a block diagram showing electrical connection in an information terminal.

FIG. 3 is a block diagram showing electrical connection in a station.

FIG. 4 is a schematic view showing the file structure of a category file.

FIG. 5 is a schematic view showing the file structure of a PLU file.

FIG. 6 is a block diagram showing the functional configuration of the information terminal.

FIG. 7 is a front view showing an exemplary order input screen.

FIG. 8 is a flowchart showing a flow of order processing.

FIG. 9 is a schematic view schematically showing the display configuration of menu buttons.

FIG. 10 is a front view showing an exemplary order input screen.

FIG. 11 is a front view showing an exemplary order input screen.

### DETAILED DESCRIPTION

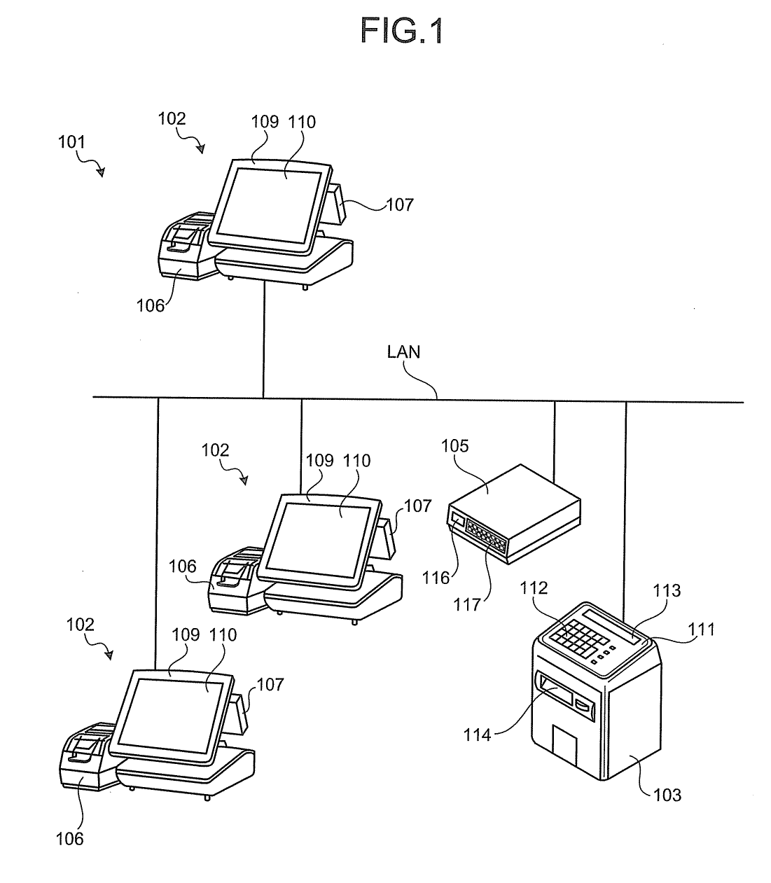

An embodiment of the invention will be described with reference FIG. 1 to FIG. 11. This embodiment is an example where an information terminal of a customer service assistance system which assists in the entire flow of customer services including guiding incoming customers to a table arranged in a serving floor, accepting orders, and waiting (serving), is used as an order accepting device.

FIG. 1 is a view of system configuration schematically showing the overall configuration of a customer service assistance system. A customer service assistance system 101 shown in FIG. 1 has an information terminal 102 installed in the serving floor and on the checkout counter, a kitchen printer 103 installed in the kitchen, a station 105 as a server that is installed in the backyard of the store and controls the entire customer service system 101, and so on.

There is no difference in the basic structure and functions between the information terminal 102 installed in the serving floor and the information terminal 102 installed on the checkout counter. The difference is how the information terminal 102 is used. That is, the information terminal 102 installed in the serving floor assists in services such as guiding customers, accepting orders, and waiting (serving). Meanwhile, the information terminal 102 installed on the checkout counter assists in accounting in addition to the above services. That is, the information terminal 102 installed on the checkout counter functions as a so-called POS terminal as well. Thus, a printer 106 to issue receipts and slips is connected to both the information terminal 102 installed in the serving floor and the information terminal 102 installed on the checkout counter. However, to the information terminal 102 installed on the checkout counter, a customer-side display device 107 as well as the printer 106 is connected.

The information terminal 102 has a liquid crystal display 109 as a display device placed on the top of a body unit 108. The information terminal 102 has a touch panel 110 as an input device stacked on the display surface of the liquid crystal display 109. The printer 106 is installed close to the information terminal 102 and is connected to the information terminal 102 via an interface such as USB.

The customer-side display device 107 is, for example, an LED display device performing 7-segment display and is installed on the top of the body unit 108 of the information terminal 102. Similarly to the printer 106, the customer-side display device 107 is connected to the information terminal 102 via an interface such as USB.

The top side of the kitchen printer 103 is an operation display surface 111, as shown in FIG. 1. The kitchen printer 103 has a keyboard 112 and a display unit 113 arranged on the operation display surface 111. The kitchen printer 103 has, for example, a built-in thermal printer (not shown) and prints and issues cooking indication slips (not shown) for cooks working in the kitchen. The kitchen printer 103 issues cooking indication slips through a slip issue port 114 arranged on the front side.

The station 105 has a small-size liquid crystal display 116 and a keyboard 117, as shown in FIG. 1. The station 105 executes management or the like of various kinds of information sent from each information terminal 102.

The information terminals 102, the kitchen printer 103 and the station 105, outlined above, are connected so that data can be freely transmitted and received to and from each other via a LAN. The information terminals 102 accept input of guide information about guiding customers to a table and order information about orders of menu items. The information terminals 102 transmit the inputted order information to the station 105 via the LAN. The station 105 then transmits the order information to the kitchen printer 103 via the LAN. The kitchen printer 103 prints and issues a slip showing a content corresponding to the received order information. A slip that is printed and issued by the kitchen printer 103 is a cooking indication slip to indicate ordered menu items to cooks in the kitchen, as described above. The information terminal 102 functioning as a POS terminal executes accounting.

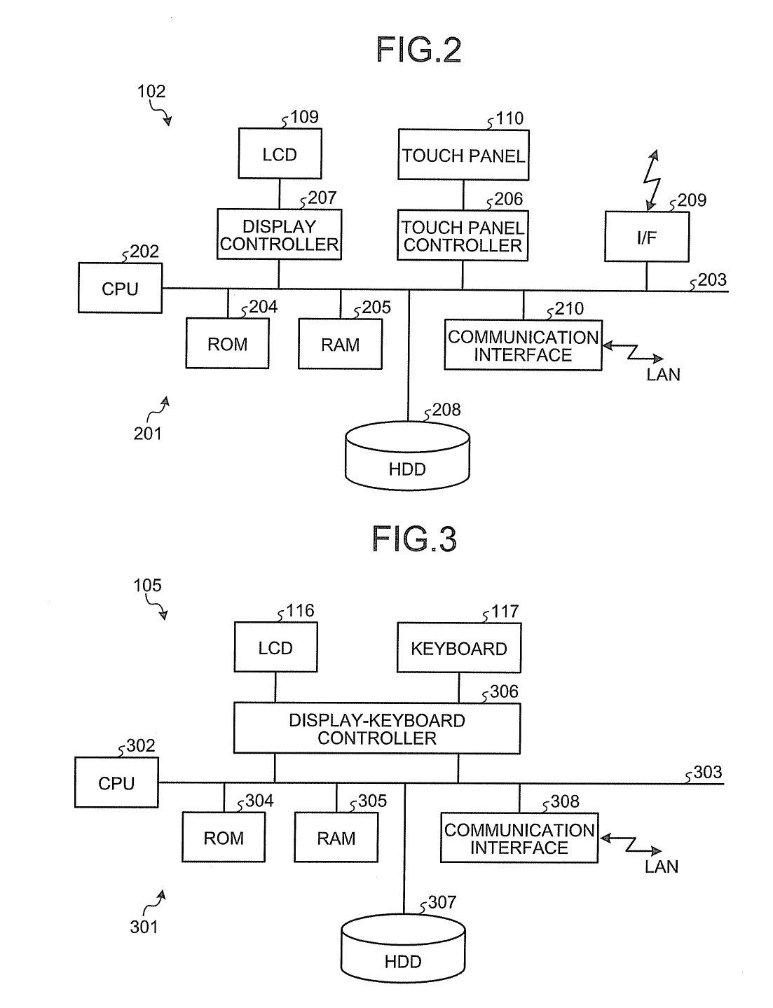

FIG. 2 is a block diagram showing electrical connection in the information terminal 102. The information terminal 102 has a microcomputer 201. The microcomputer 201 controls driving of each unit. The microcomputer 201 has a ROM 204 which stores fixed information such as control programs in advance and a RAM 205 which rewritably stores various kinds of information and functions as a work area or the like, connected via a bus line 203 to a CPU 202 which centrally controls each unit. Therefore, the microcomputer 201 constitutes an information processing unit which executes information processing.

The microcomputer 201 has a touch panel controller 206, a display controller 207, an HDD 208, an interface 209 and a communication interface 210 connected via the bus line 203. The touch panel controller 206 takes an input signal from the touch panel 110 into the microcomputer 201. The display controller 207 controls driving of the liquid crystal display 109 in accordance with image data and causes the liquid crystal display 109 to display images corresponding to the image data. The interface 209 is an interface to connect the printer 106 and the customer-side display device 107 to the microcomputer 201. The interface 209 is a USB or the like, as described above. The communication interface 210 is an interface to communicate data between the microcomputer 201 and other devices via a LAN.

An OS, computer programs, various files and so on are installed in the HDD 208. The CPU 202 executes processing according to the OS and computer programs.

FIG. 3 is a block diagram showing electrical connection in the station 105. The station 105 has a microcomputer 301 which controls driving of each unit. The microcomputer 301 has a ROM 304 which stores fixed information such as control programs in advance and a RAM 305 which rewritably stores various kinds of information and functions as a work area or the like, connected via a bus line 303 to a CPU 302 which centrally controls each unit. Therefore, the microcomputer 301 constitutes an information processing unit which executes information processing.

The microcomputer 301 has a display-keyboard controller 306, an HDD 307 and a communication interface 308 connected via the bus line 303. The display-keyboard controller 306 controls driving of the liquid crystal display 116 in accordance with image data and thereby causes the liquid crystal display 116 to display images corresponding to the image data. The display-keyboard controller 306 also takes an input signal from the keyboard 117 into the microcomputer 301. The communication interface 308 is an interface to enable communication of data between the microcomputer 301 and other devices via a LAN.

An OS, computer programs, various files and so on are installed in the HDD 307. All or a part of these OS, computer programs, various files and so on is copied to the RAM 305 and accessed by the CPU 302 when the station 105 is started up. The CPU 302 executes processing according to the OS and computer programs thus copied.

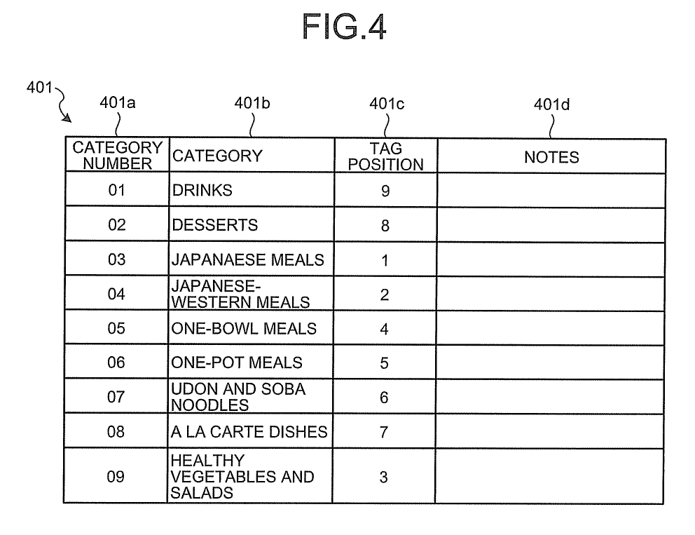

FIG. 4 is a schematic view showing the file structure of a category file 401 that is accessible to the information terminals 102 and the station 105. The category file 401 is installed in the HDD 208 of each of the information terminals 102 and in the HDD 307 of the station 105.

In the category file 401, categories 401b, tag positions 401c and notes 401d are registered in association with two-digit category numbers 401a specifying categories. In the category number section 401a, for example, the following categories are registered.

01: drinks

02: desserts

03: Japanese meals

04: Japanese-Western meals

05: one-bowl meals

06: one-pot meals

07: udon and soba noodles

08: a la carte dishes

09: healthy vegetables and salads

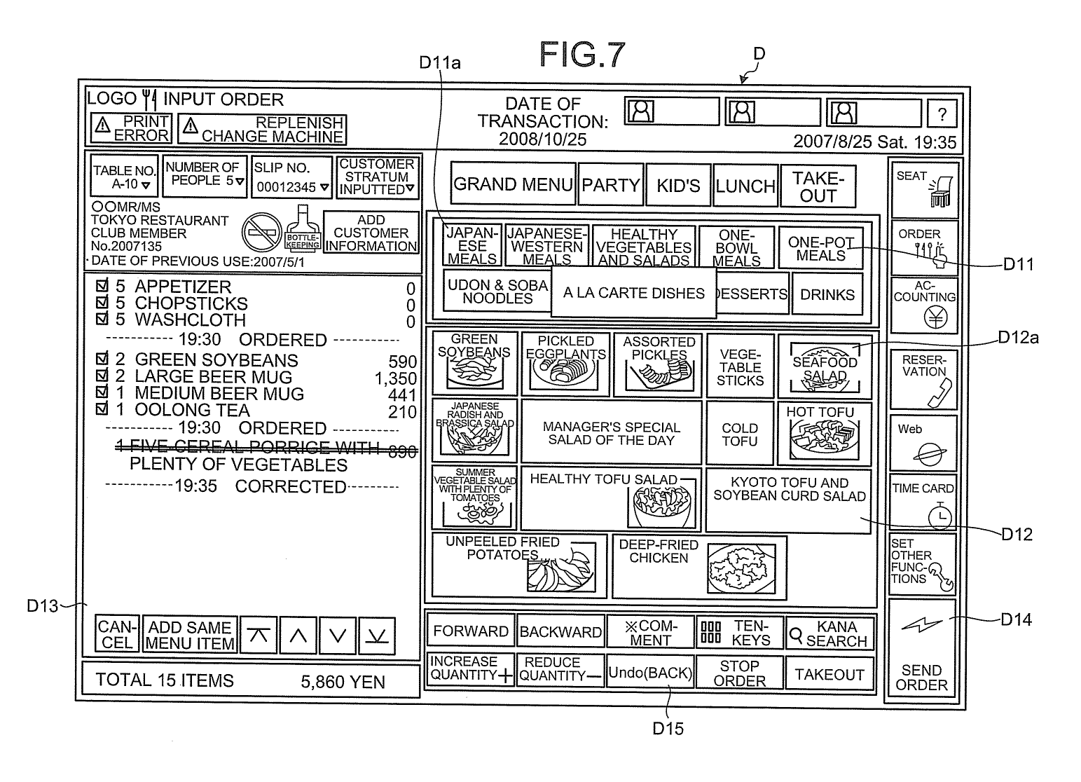

In the category section 401b, the category name of each category is registered. In the tag position section 401c, the arrangement of a main button D11b and a sub button D11c displaying a category name in a category tag section D11a (see FIG. 7) is registered. In this embodiment, in the tag position section 401c, the row and column indicating the position of the main button D11b and the sub button D11c is registered as the arrangement of the main button D11b and the sub button D11c. The notes section 401d is, for example, a section where various kinds of information can be written in the form of texts for information management.

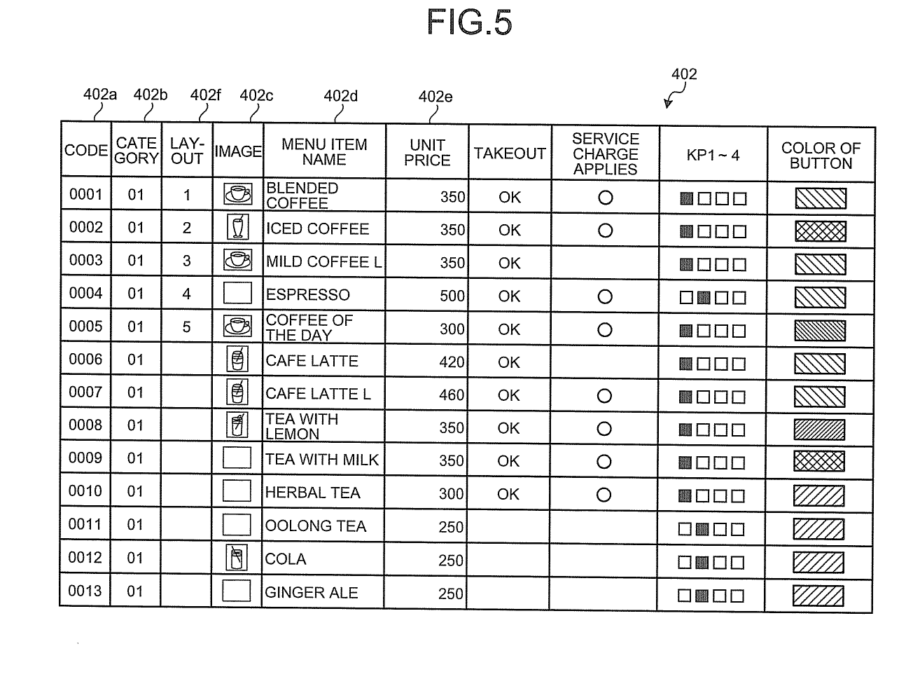

FIG. 5 is a schematic view showing the file structure of a PLU file 402 accessible to the information terminals 102 and the station 105. The PLU file 402 is installed in the HDD 208 of each of the information terminals 102 and in the HDD 307 of the station 105.

In the PLU file 402, categories 402b, image links 402c, menu item names 402d, unit prices 402e and layouts 402f are registered in association with codes 402a specifying menu items. The categories 402b represent the category numbers 401b in the category file 401. The image links 402c define links to image data displayed on menu buttons D12a in a menu item section D12 (see FIG. 7). These images are installed in the HDD 208 of each of the information terminals 102 and in the HDD 307 of the station 105. In the menu item name section 402d, the names of menu items are registered in the form of texts. In the unit price section 402e, the record of unit prices of menu items is registered. In the layout section 402f, the layout positions of the menu buttons D12a for menu items in the menu item section D12 (see FIG. 7) are registered.

For example, as can be seen from FIG. 4 and FIG. 5, a code “0001” specifying a menu item defines “blended coffee” in the “drinks” category and sets a unit price of “¥350”. A code “0002” defines “iced coffee” in the “drinks” category and sets a unit price of “¥350”.

Next, of processing executed by the microcomputer 201 in accordance with the OS and computer programs installed in the HDD 208 of the information terminals 102, characteristic processing in the information terminals 102 according to this embodiment will be described.

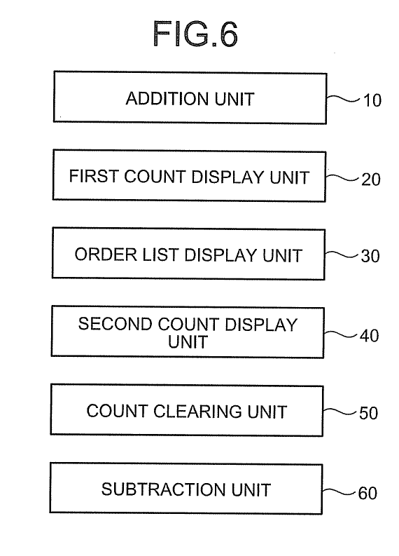

The computer program executed by the information terminals 102 has a module configuration including units as shown in FIG. 6 (an addition unit 10, a first count display unit 20, an order list display unit 30, a second count display unit 40, a count clearing unit 50, and a subtraction unit 60). The CPU 202 of the microcomputer 201 reads out the computer program from the HDD 208 and executes the computer program, thus loading the respective units onto the RAM 205. The addition unit 10, the first count display unit 20, the order list display unit 30, the second count display unit 40, the count clearing unit 50 and the subtraction unit 60 are thus generated on the RAM 205.

The CPU 202 of the microcomputer 201 of the information terminal 102 displays an order input screen D as shown in FIG. 7 on the liquid crystal display 109 on the basis of the OS and computer programs installed in the HDD 208. The order input screen D shows a category tag D11, a menu item section D12, an order list D13, service designation keys D14, function keys D15 and so on.

The category tags D11 display category buttons D11a showing category names in the form of texts registered in the category section 401b in the category file 401, as objects that can be designated by touch on the touch panel 110.

In the menu item section D12, in the initial state, the menu buttons D12a including the image data of link destinations defined by the image links 402c and articles names in the form of texts available for ordering registered in the menu item name section 402d corresponding to the codes 402a in the PLU file 402 are displayed as objects that can be designated by touch on the touch panel 110.

The order list D13 shows a list of menu items, the number of orders and the amount (the unit price×the number of orders) designated by touch on the order input screen D through the touch panel 110.

As the service designation keys D14, keys to designate execution of various services such as “accounting” for execution of accounting or “send order” for execution of sending of an order are displayed as objects that can be designated by touch on the touch panel 110.

As the function keys D15, keys to designate execution of various functions such as “increase quantity” for execution of processing to increase the number of orders or “reduce quantity” for execution of processing to reduce the number of orders are displayed as objects that can be designated by touch on the touch panel 110.

In the case of inputting a menu item from the order input screen D, the user selects a desired category from “drinks”, “desserts”, “Japanese meals”, “Japanese-Western meals”, “one-bowl meals”, “one-pot meals”, “udon & soba noodles”, “a la carte dishes”, and “healthy vegetables and salads” by designating a desired category tag D11 by touch. For example, if the category button D11a of “a la carte dishes”, of the category tags D11, is designated by touch, the exemplary order input screen D for “a la carte dishes” shown in FIG. 7 is displayed.

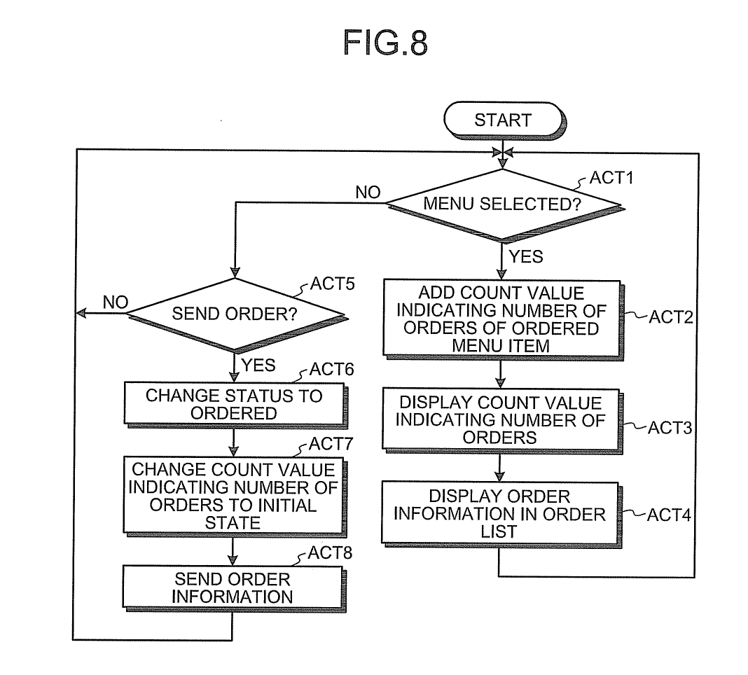

Next, order processing via the order input screen D as described above will be described. FIG. 8 is a flowchart showing the flow of order processing. As shown in FIG. 8, in order processing, if it is determined that one of the menu buttons D12a in the menu item section D12 in the order input screen D is touched and a menu item is thus selected (Yes in ACT 1), the microcomputer 201 of the information terminal 102 adds the count value indicating the number of orders for the ordered menu item on the menu button D12a in the menu item section D12 in the order input screen D (ACT 2: the addition unit 10). The microcomputer 201 of the information terminal 102 also displays the count value indicating the number of orders in a visually recognizable manner (ACT 3: the first count display unit 20) and displays order information (the count value indicating the number of orders, item name and unit price) of the item designated by touch and ordered, in the order list D13 in the order input screen D (ACT 4: the order list display unit 30 and the second count display unit 40).

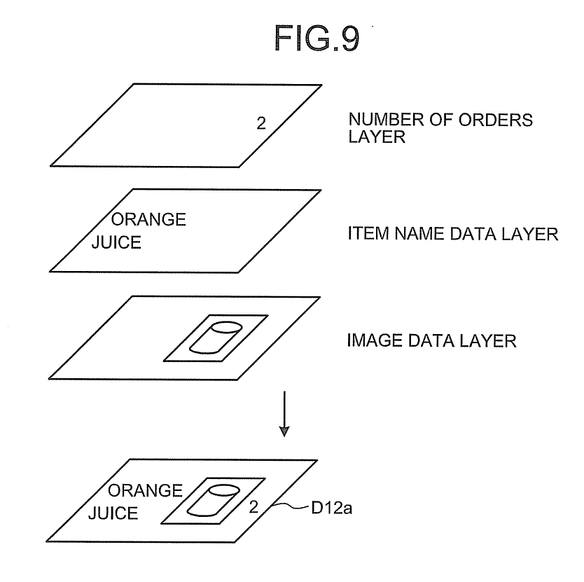

FIG. 9 is a schematic view schematically showing the display configuration of the menu button D12a. As shown in FIG. 9, the menu button D12a has a three-layer configuration including an image data layer where image data showing the appearance of the article is set, an item name data layer where item name data showing the article name of the article is set, and a number of orders layer where number of orders data showing the number of orders is set. In the display of the initial state of the menu button D12a (the menu button D12a on which the number of orders of the menu item is not displayed), the image data layer, the item name data layer, and the number of orders layer where the number of orders data showing the number of orders is not set, are superimposed by the CPU 202 (the first count display unit 20) of the microcomputer 201 of the information terminal 102. That is, on the menu button D12a in the initial state as shown in FIG. 7, the number of orders of the menu item is not shown but the number of orders is “0”. Such menu buttons D12a in the menu item section D12 are set basically in four rows by five columns. However, it is also possible to create menu buttons D12a using two normal button areas as one button.

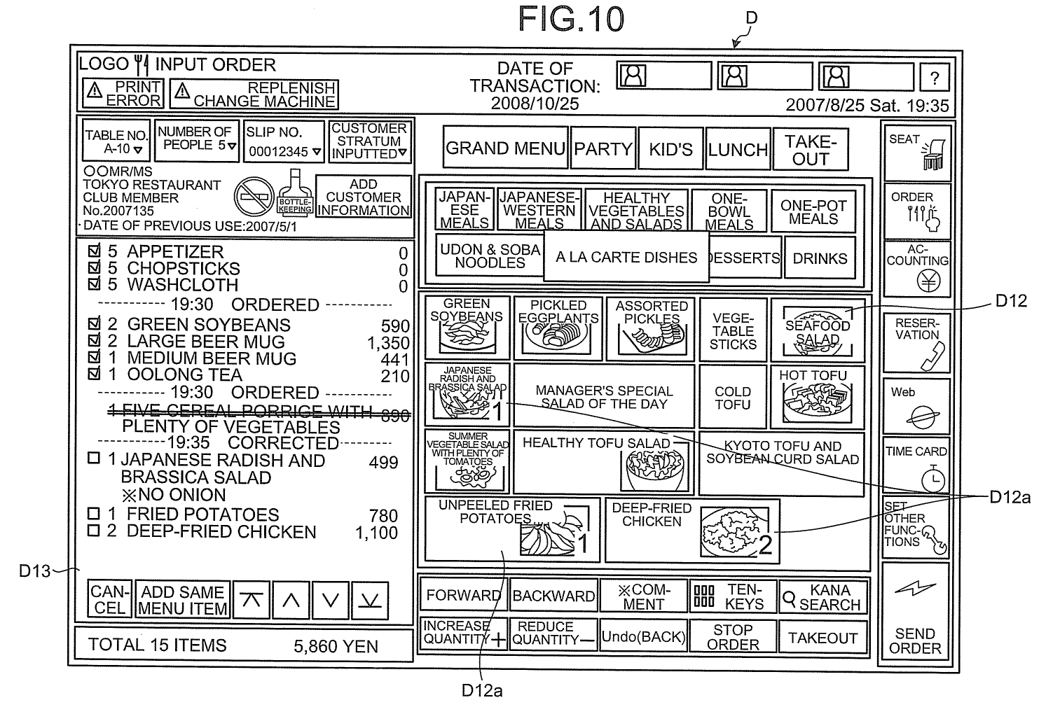

Here, the order list D13 in the order input screen D shown in FIG. 10 shows an example where one “Japanese radish and brassica salad”, one “fried potatoes”, and two “deep-fried chickens” are ordered. In this case, a count value “1” indicating the number of orders on the menu button D12a of “Japanese radish and brassica salad”, a count value “1” indicating the number of orders on the menu button D12a of “fried potatoes”, and a count value “2” indicating the number of orders on the menu button D12a of “deep-fried chickens” are displayed in the menu item section D12 in the order input screen D. That is, before the “send order” key of the service designation keys D14 is operated, the number of orders in the order list D13 in the order input screen D is coincident with the number of orders on the menu buttons D12a (the number of orders data set in the number of orders layer).

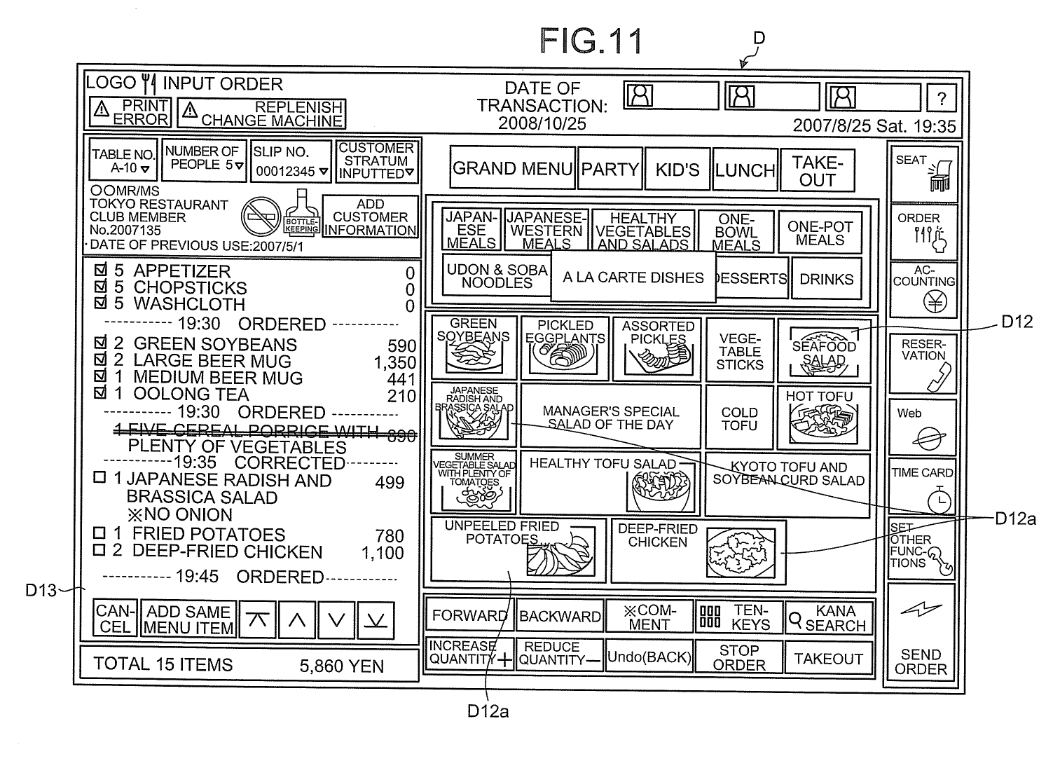

Referring again to the flowchart of FIG. 8, the processing of ACT 1 to ACT 4 as described above is repeated. If it is determined that the “send order” key of the service designation keys D14 is touched and sending of the order is designated (Yes in ACT 5), the microcomputer 201 of the information terminal 102 changes the status of “Japanese radish and brassica salad”, “fried potatoes” and “deep-fried chickens” in the order list D13 in the order input screen D to “ordered” (ACT 6), as shown in FIG. 11. The microcomputer 201 of the information terminal 102 also changes the count value indicating the number of orders (the number of orders data set in the number of orders layer) on the menu buttons D12a of “Japanese radish and brassica salad”, “fried potatoes” and “deep-fried chickens” in the menu item section D12 in the order input screen D to the initial state, that is, “0”, and restores the initial state of display of the number of orders (ACT 7: the count clearing unit 50). In this manner, if the count clearing unit 50 restores the initial state, that is, “0”, of the count value indicating the number of orders (the number of orders data set in the number of orders layer) on the menu buttons D12a, the first count display unit 20 does not display the number of orders of the menu items on the menu buttons D12a, either.

In addition, the “ordered” menu items, the number of orders, the amount (the unit price×the number of orders) and so on, displayed in the order list D13 in the order input screen D, are stored as order information in the work area of the RAM 205. The microcomputer 201 of the information terminal 102 decides the order information such as the number of orders in response to a touch on the “send order” key of the service designation keys D14 and sends the decided order information to the station 105 via the LAN (ACT 8). That is, if the “send order” key of the service designation keys D14 is touched, the count value indicating the number of orders displayed on the menu buttons D12a is deleted and the order information including the number of orders is decided.

Before the “send order” key of the service designation keys D14 is operated, the microcomputer 201 of the information terminal 102 increases or reduces the count value indicating the number of orders by operating the “increase quantity” key or the “reduce quantity” key of the function keys D15 with respect to the number of orders in the order list D13 in the order input screen D and the number of orders on the menu buttons D12a (the subtraction unit 60).

In this manner, according to this embodiment, every time a menu button having an article name available for ordering attached thereto and accepting an operation by the operator is operated, the count value indicating the number of orders of the article corresponding to the operated menu button is added and the added count value indicating the number of orders is displayed on the menu button in a visually recognizable manner. Thus, in the case of operating a menu button plural times consecutively for ordering plural units of the same item, it suffices the operator simply checks the count value indicating the number of orders displayed on the menu button in order to confirm whether the number of times of operation reaches the number of orders. Therefore, an order accepting device that has very good operability and realizes convenience for the operator can be provided.

Further advantages and modifications can be easily led out by those skilled in the art. Therefore, broader embodiments of the invention are not limited to the specific details and representative embodiments described and shown above. Thus, various modifications and alterations can be made without departing from the general spirit and scope of the invention defined by the attached claims and their equivalents.

What is claimed is:

1. An order accepting device comprising:
an addition unit which, every time a menu button having an article name attached thereto and accepting an operation by an operator is operated, adds a count value indicating the number of orders of an article corresponding to the operated menu button; and
a first count display unit which displays the count value indicating the number of orders obtained by the addition unit, on the menu button.

2. The device according to claim 1, further comprising:
an order list display unit which displays an order list in which an article name corresponding to the operated menu button is displayed; and
a second count display unit which displays the count value indicating the number of orders obtained by the addition unit in the order list.

3. The device according to claim 1, wherein if the count value indicating the number of orders is in an initial state, the first count display unit does not display the count value indicating the number of orders on the menu button.

4. The device according to claim 1, further comprising:
an order sending key for execution of sending of an order accepted as the menu button is operated, to a host device; and
a count clearing unit which returns the count value indicating the number of orders displayed on the menu button to an initial state if the order sending key is operated.

5. The device according to claim 4, further comprising a subtraction unit which subtracts the count value indicating the number of orders obtained by the addition unit only before the order sending key is operated.

6. The device according to claim 4, wherein if the order sending key is operated, the count value indicating the number of orders displayed on the menu button is deleted and order information including the number of orders is decided.

7. A method for displaying the number of orders executed in an order accepting device which has, for each article, a menu button having an article name attached thereto and accepting an operation by an operator,
the order accepting device having a control unit and a storage unit,
the method comprising the following, which is executed by the control unit:
an addition unit adding a count value indicating the number of orders of an article corresponding to the operated menu button every time the menu button is operated; and
a first count display unit displaying the count value indicating the number of orders obtained by the addition unit, on the menu button.

8. The method according to claim 7, further comprising the following, which is executed by the control unit:
an order list display unit displaying an order list in which an article name corresponding to the operated menu button is displayed; and
a second count display unit displaying the count value indicating the number of orders obtained by the addition unit in the order list.

9. The method according to claim 7, wherein if the count value indicating the number of orders is in an initial state, the first count display unit does not display the count value indicating the number of orders on the menu button.

10. The method according to claim 7, further comprising the following, which is executed by the control unit:
a count clearing unit returning the count value indicating the number of orders displayed on the menu button to an initial state if an order sending key for execution of sending of an order accepted as the menu button is operated, to a host device, is operated.

11. The method according to claim 10, further comprising the following, which is executed by the control unit:
a subtraction unit subtracting the count value indicating the number of orders obtained by the addition unit only before the order sending key is operated.
